(19) United States
(12) Patent Application Publication
(10) Pub. No.: US 2024/0087357 A1
(43) Pub. Date: Mar. 14, 2024

(54) Voter Authentication And Voting Device

(71) Applicant: Tete Weston, Bellevue, WA (US)

(72) Inventor: Tete Weston, Bellevue, WA (US)

(21) Appl. No.: 17/943,884

(22) Filed: Sep. 13, 2022

(51) Int. Cl. G06V 40/12; G07C 13/00

(52) U.S. Cl. CPC G06V 40/1365; G07C 13/00; G06Q 2230/00

(57) ABSTRACT

A voter authentication and voting device for authenticating a user's permission to vote and tallying the user's vote if permitted includes a housing defining an interior space and having a slot extending through said housing being configured for receiving a ballot into said interior space. A microprocessor compares a user fingerprint scanned by a fingerprint scanner to a plurality of valid voter fingerprints in a database. A ballot scanner scans the ballot when it is received into the interior space. Only if the user fingerprint matches one of the plurality of valid voter fingerprints does the microprocessor add votes as indicated on the ballot to a vote tally stored on a data storage module. A method of voter authentication and voting is also disclosed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to voter authentication and voting devices and more particularly pertains to a new voter authentication and voting device for authenticating a user's permission to vote and tallying the user's vote if permitted.

### (2) Description of Related Art Including Information Disclosed Under 37 CFR 1.97 and 1.98

The prior art relates to voter authentication and voting devices and methods which rely on biometric inputs for authentication of voters and tallying of voting selections. However, the prior art does not disclose a device which authenticates voters using a fingerprint scanner and accepts a paper ballot into a slot in the device for scanning and tallying of voting selections made on the paper ballot.

### BRIEF SUMMARY OF THE INVENTION

An embodiment of the disclosure meets the needs presented above by generally comprising a housing defining an interior space and having a slot extending through said housing being configured for receiving a ballot into said interior space. A microprocessor compares a user fingerprint scanned by a fingerprint scanner to a plurality of valid voter fingerprints in a database. A ballot scanner scans the ballot when it is received into the interior space. Only if the user fingerprint matches one of the plurality of valid voter fingerprints does the microprocessor add votes as indicated on the ballot to a vote tally stored on a data storage module.

Another embodiment of the disclosure includes a method comprising providing a voter authentication and voting device comprising which scans a user fingerprint and compares the user fingerprint to a plurality of valid voter fingerprints. Then the device receives a ballot into an interior space of the device and scans the ballot. The device determines a vote selection indicated on the ballot and adds it to a vote tally only if the user fingerprint matches one of the plurality of valid voter fingerprints.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a voter authentication and voting device according to an embodiment of the disclosure.

FIG. 2 is a top view of an embodiment of the disclosure.

FIG. 3 is a front view of an embodiment of the disclosure.

FIG. 4 is an in-use view of an embodiment of the disclosure.

### DETAILED DESCRIPTION OF THE INVENTION

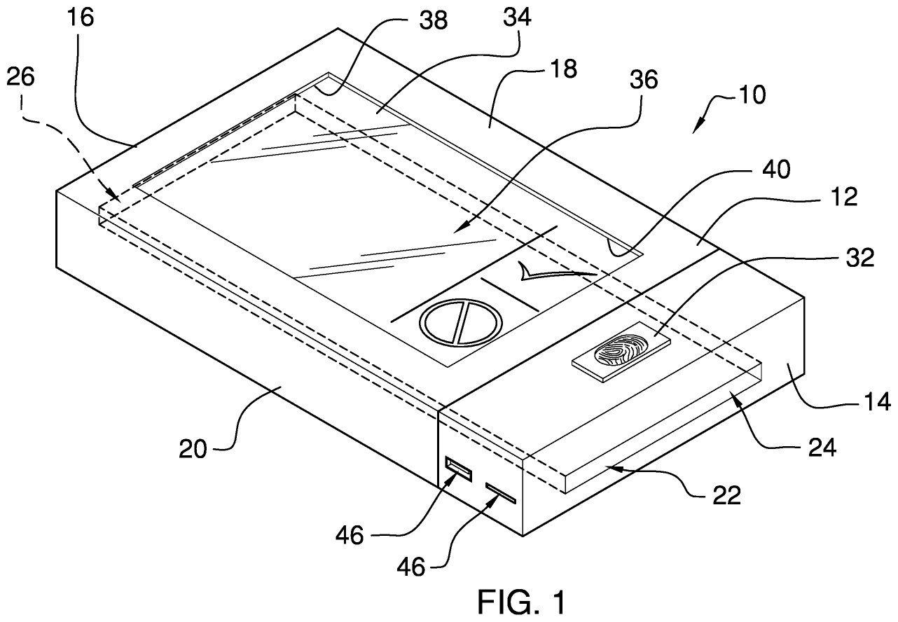

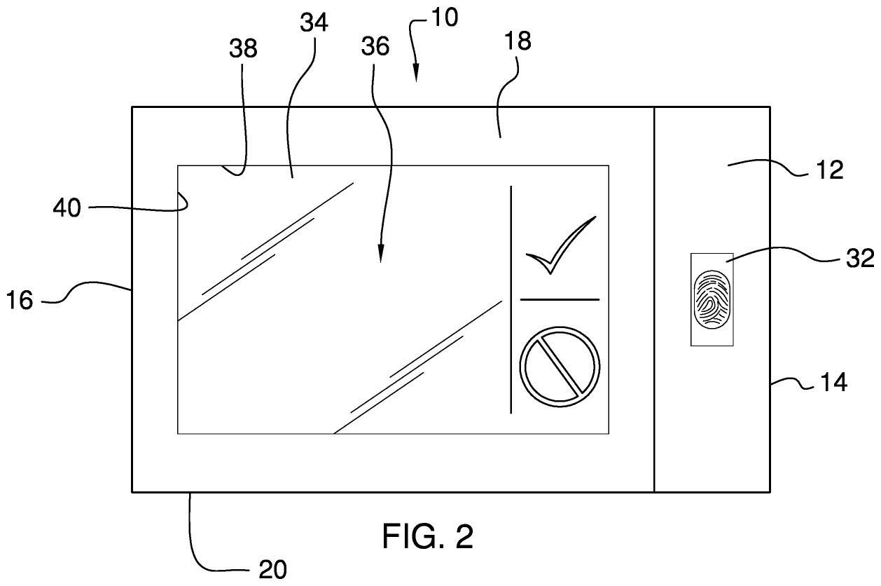

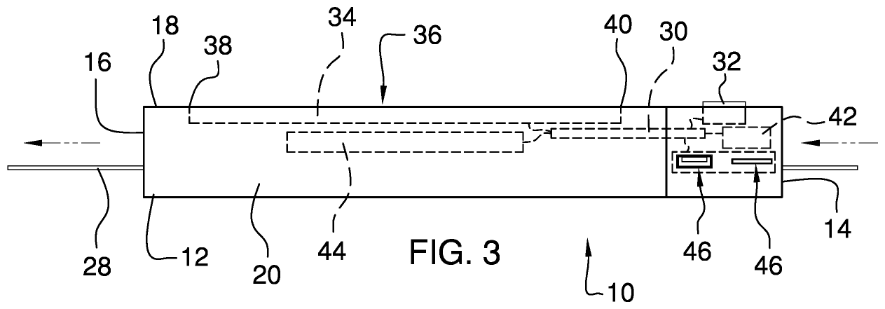

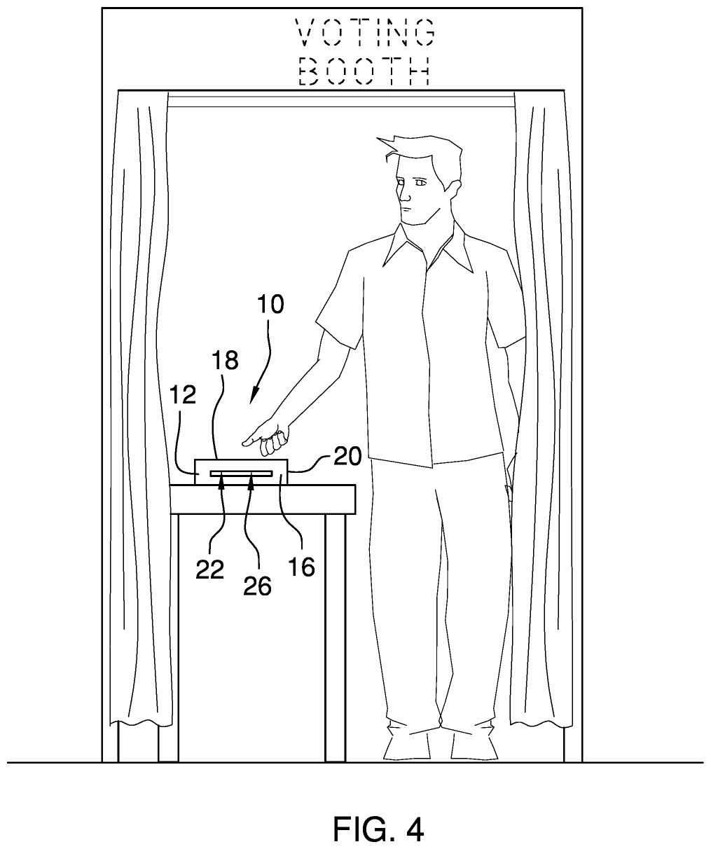

With reference now to the drawings, and in particular to FIGS. 1 through 4 thereof, a new voter authentication and voting device embodying the principles and concepts of an embodiment of the disclosure and generally designated by the reference numeral 10 will be described.

As best illustrated in FIGS. 1 through 4, the voter authentication and voting device 10 generally comprises a housing 12 defining an interior space. The housing 12 has a first end 14 and a second end 16, and the housing 12 has a top side 18 extending between the first end 14 and the second end 16. The housing 12 also has a front side 20 adjacent the top side 18 and extending between the first end 14 and the second end 16. A slot 22 extends between the first end 14 and the second end 16 and has a first opening 24 on the first end 14 and a second opening 26 on the second end 16. Each of the first opening 24 and the second opening 26 is rectangular, and the slot 22 is configured for receiving a ballot 28 into the interior space. A microprocessor 30 is positioned within the interior space and is coupled to the housing 12. The microprocessor 30 is configured for communicating with a database storing a plurality of valid voter fingerprints.

A fingerprint scanner 32 is positioned partially within the interior space and is coupled to the housing 12 proximate the first end 14. The fingerprint scanner 32 extends through the top side 18 of the housing 12. The fingerprint scanner 32 is operationally coupled to the microprocessor 30 and is configured for scanning a user fingerprint, the microprocessor 30 is configured for thereafter comparing the user fingerprint with the plurality of valid voter fingerprints in the database.

A display module 34 is coupled to the housing 12 and positioned within the interior space proximate the second end 16 of the housing 12. The display module 34 is aligned with and visible through an aperture 36 in the top side 18 of the housing 12. The display module 34 has a peripheral edge 38 positioned in abutment with an interior surface 40 of the housing 12 such that the display module 34 fully obstructs access to the interior space through the aperture 36. The display module 34 may alternatively be coupled to an exterior surface of the housing 12 or integrated into the housing 12. The display module 34 is operationally coupled to the microprocessor 30, is configured for displaying a successful authentication message if the user fingerprint matches one of the plurality of valid voter fingerprints, and is configured for displaying a failed authentication message if the user fingerprint does not match any of the plurality of valid voter fingerprints.

A data storage module 42 is positioned within the interior space, is coupled to the housing 12, and is operationally coupled to the microprocessor 30. A ballot scanner 44 is also positioned within the interior space, is coupled to the housing 12, and is operationally coupled to the microprocessor 30. The ballot scanner 44 is positioned above and adjacent to the slot 22 and is configured for scanning the ballot 28 when the ballot 28 is received into the interior space. The microprocessor 30 is configured to thereafter determine a vote selection indicated on the ballot 28 and add it to a vote tally stored on the data storage module 42 only if the user fingerprint matches one of the plurality of valid voter fingerprints. A pair of peripheral data storage ports 46 extends through the front side 20 of the housing 12 proximate the first end 14. Each peripheral data storage port 46 is electrically coupled to the microprocessor 30, and the microprocessor 30 is configured for selectively transferring the vote tally to each peripheral data storage port 46 if a peripheral data storage device is electrically coupled to a complementary one of the pair of peripheral data storage ports 46.

In use, the fingerprint scanner 32 scans a user fingerprint, and the microprocessor compares the user fingerprint to the plurality of valid voter fingerprints. Then the display module 34 displays a failed authentication message if the user fingerprint does not match any of the plurality of valid voter fingerprints or a successful authentication message if the user fingerprint matches one of the plurality of valid voter fingerprints. The ballot 28 is received through the slot 22 into the interior space, and the ballot scanner 44 scans the ballot 28. The microprocessor 30 then determines a vote selection indicated on the ballot 28 and adds it to a vote tally stored on the data storage module 42 only if the user fingerprint matches one of the plurality of valid voter fingerprints.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A voter authentication and voting device comprising:
a housing, said housing defining an interior space;
a slot extending through said housing being configured for receiving a ballot into said interior space;
a microprocessor being configured for communicating with a database storing a plurality of valid voter fingerprints;
a fingerprint scanner being operationally coupled to said microprocessor, said fingerprint scanner being configured for scanning a user fingerprint, said microprocessor being configured for thereafter comparing the user fingerprint with the plurality of valid voter fingerprints in the database;
a data storage module being operationally coupled to said microprocessor; and
a ballot scanner being operationally coupled to said microprocessor, said ballot scanner being positioned adjacent to said slot, said ballot scanner being configured for scanning the ballot when the ballot is received into said interior space, said microprocessor being configured to thereafter determine a vote selection indicated on the ballot and add it to a vote tally stored on said data storage module only if the user fingerprint matches one of said plurality of valid voter fingerprints.

2. The device of claim 1, further comprising:
said microprocessor being positioned within said interior space and being coupled to said housing;
said fingerprint scanner being positioned partially within said interior space and being coupled to said housing, said fingerprint scanner extending through a wall of said housing;
said data storage module being positioned within said interior space and being coupled to said housing; and
said ballot scanner being positioned above said slot.

3. The device of claim 1, further comprising:
said housing having a first end and a second end, said housing having a top side extending between said first end and said second end, said housing having a front side adjacent said top side and extending between said first end and said second end;
said slot having a first opening on said first end and a second opening on said second end;
said microprocessor being positioned within said interior space and being coupled to said housing;
said fingerprint scanner being positioned partially within said interior space and being coupled to said housing proximate said first end, said fingerprint scanner extending through said top side of said housing, said fingerprint scanner being operationally coupled to said microprocessor;
said data storage module being positioned within said interior space and being coupled to said housing; and
said ballot scanner being positioned above said slot.

4. The device of claim 1, further comprising a display module, said display module being operationally coupled to said microprocessor, said display module being configured for displaying a successful authentication message if the user fingerprint matches one of the plurality of valid voter fingerprints, said display module being configured for displaying a failed authentication message if the user fingerprint does not match any of said plurality of valid voter fingerprints.

5. The device of claim 4, further comprising said display module being coupled to an exterior surface of said housing.

6. The device of claim 4, further comprising said display module being integrated into said housing.

7. The device of claim 4, further comprising said display module being coupled to said housing and positioned within said interior space proximate said second end of said housing, said display module being visible through an aperture in said housing.

8. The device of claim 7, further comprising said display module being aligned with said aperture, said display module having a peripheral edge positioned in abutment with an interior surface of said housing such that said display module fully obstructs access to said interior space through said aperture.

9. The device of claim 3, further comprising a display module being coupled to said top side of said housing, said display module being operationally coupled to said microprocessor, said display module being configured for displaying a successful authentication message if the user fingerprint matches one of the plurality of valid voter fingerprints, said display module being configured for displaying a failed authentication message if the user fingerprint does not match any of said plurality of valid voter fingerprints.

10. The device of claim 9, further comprising said display module being positioned within said interior space proximate said second end of said housing, said display module being aligned with and visible through an aperture in said top side of said housing, said display module having a peripheral edge positioned in abutment with an interior surface of said housing such that said display module fully obstructs access to said interior space through said aperture.

11. The device of claim 1, further comprising a peripheral data storage port extending through a wall of said housing, said peripheral data storage port being electrically coupled to said microprocessor, said microprocessor being configured for selectively transferring the vote tally to said peripheral data storage port if a peripheral data storage device is electrically coupled to said peripheral data storage port.

12. The device of claim 11, further comprising said peripheral data port being one of a pair of peripheral data storage ports, each said peripheral data storage port extending through said wall of said housing, each said peripheral data storage port being electrically coupled to said microprocessor, said microprocessor being configured for selectively transferring the vote tally to each said peripheral data storage port if a peripheral data storage device is electrically coupled to a complementary one of said pair of peripheral data storage ports.

13. The device of claim 3, further comprising a peripheral data storage port extending through said front side of said housing proximate said first end, said peripheral data storage port being electrically coupled to said microprocessor, said microprocessor being configured for selectively transferring the vote tally to said peripheral data storage port if a peripheral data storage device is electrically coupled to said peripheral data storage port.

14. The device of claim 13, further comprising said peripheral data port being one of a pair of peripheral data storage ports, each said peripheral data storage port extending through said front side of said housing proximate said first end, each said peripheral data storage port being electrically coupled to said microprocessor, said microprocessor being configured for selectively transferring the vote tally to each said peripheral data storage port if a peripheral data storage device is electrically coupled to a complementary one of said pair of peripheral data storage ports.

15. A voter authentication and voting device comprising:
a housing defining an interior space, said housing having a first end and a second end, said housing having a top side extending between said first end and said second end, said housing having a front side adjacent said top side and extending between said first end and said second end;
a slot extending between said first end and said second end, said slot having a first opening on said first end and a second opening on said second end, each of said first opening and said second opening being rectangular, said slot being configured for receiving a ballot into said interior space;
a microprocessor being positioned within said interior space and being coupled to said housing, said microprocessor being configured for communicating with a database storing a plurality of valid voter fingerprints;
a fingerprint scanner being positioned partially within said interior space and being coupled to said housing proximate said first end, said fingerprint scanner extending through said top side of said housing, said fingerprint scanner being operationally coupled to said microprocessor, said fingerprint scanner being configured for scanning a user fingerprint, said microprocessor being configured for thereafter comparing the user fingerprint with the plurality of valid voter fingerprints in the database;
a display module being coupled to said housing and positioned within said interior space proximate said second end of said housing, said display module being aligned with and visible through an aperture in said top side of said housing, said display module having a peripheral edge positioned in abutment with an interior surface of said housing such that said display module fully obstructs access to said interior space through said aperture, said display module being operationally coupled to said microprocessor, said display module being configured for displaying a successful authentication message if the user fingerprint matches one of the plurality of valid voter fingerprints, said display module being configured for displaying a failed authentication message if the user fingerprint does not match any of said plurality of valid voter fingerprints;
a data storage module being positioned within said interior space and being coupled to said housing, said data storage module being operationally coupled to said microprocessor;
a ballot scanner being positioned within said interior space and being coupled to said housing, said ballot scanner being operationally coupled to said microprocessor, said ballot scanner being positioned above and adjacent to said slot, said ballot scanner being configured for scanning the ballot when the ballot is received into said interior space, said microprocessor being configured to thereafter determine a vote selection indicated on the ballot and add it to a vote tally stored on said data storage module only if the user fingerprint matches one of said plurality of valid voter fingerprints; and
a pair of peripheral data storage ports extending through said front side of said housing proximate said first end, each said peripheral data storage port being electrically coupled to said microprocessor, said microprocessor being configured for selectively transferring the vote tally to each said peripheral data storage port if a peripheral data storage device is electrically coupled to a complementary one of said pair of peripheral data storage ports.

16. A method of voter authentication and voting comprising:
providing a voter authentication and voting device comprising:
a housing, said housing defining an interior space;
a slot extending through said housing being configured for receiving a ballot into said interior space;
a microprocessor being configured for communicating with a database storing a plurality of valid voter fingerprints;
a fingerprint scanner being operationally coupled to said microprocessor;
a data storage module operationally coupled to said microprocessor; and
a ballot scanner being operationally coupled to said microprocessor, said ballot scanner being positioned adjacent to said slot;
said fingerprint scanner scanning a user fingerprint;
said microprocessor comparing the user fingerprint to said plurality of valid voter fingerprints;
receiving the ballot through said slot into said interior space;
said ballot scanner scanning the ballot; and
said microprocessor determining a vote selection indicated on the ballot and adding it to a vote tally stored on said data storage module only if the user fingerprint matches one of said plurality of valid voter fingerprints.

17. The method of claim 16, further comprising:
said voter authentication and voting device further comprising a display module being operationally coupled to said microprocessor;
said display module displaying a failed authentication message if the user fingerprint does not match any of said plurality of valid voter fingerprints; and
said display module displaying a successful authentication message if the user fingerprint matches one of said plurality of valid voter fingerprints.
